(19) United States
(12) Patent Application Publication
(10) Pub. No.: US 2024/0300611 A1
(43) Pub. Date: Sep. 12, 2024

(54) Centering Ring; Method for Reducing the Risk of Breakage of at Least One Thin-Walled Region of a Centering Ring

(71) Applicant: HWG Horst Weidner GmbH, Renningen (DE)

(72) Inventors: Sven Breitfeld, Magstadt (DE); Florian Brenner, Friolzheim (DE)

(21) Appl. No.: 18/293,386

(22) PCT Filed: Jul. 27, 2022
(86) PCT No.: PCT/DE2022/100541

§ 371 Date: Jan. 30, 2024

(30) Foreign Application Priority Data
Jul. 30, 2021 (DE) 10 2021 119 863.1

(51) Int. Cl. B62K 21/06

(52) U.S. Cl. CPC B62K 21/06

(57) ABSTRACT

A centring ring (5) and a method for reducing the risk of breakage of at least one thin-walled area of a centring ring (4) are proposed, the centring ring (5) having at least two thick-walled segments, i.e. at least one first thick-walled segment (15) and one second thick-walled segment (16), said first thick-walled segment (15) having a side surface (23) which faces a side surface (31) of the second thick-walled segment (16), said side surfaces (23, 31) touching each other at least partially or being separated from each other by a gap (37) having a given clearance B (38), and said centring ring (5) including at least one movement limiter (24, 48) which allows the side surfaces (23,31) to merely drift apart under the application of force and/or drift towards each other under the application of force until a certain clearance B (38) is reached.

### CROSS REFERENCE TO RELATED APPLICATIONS

This application is the U.S. national stage of International Application No. PCT/DE2022/100541, filed on 2022 Jul. 27. The international application claims the priority of DE 102021119863.1 filed on 2021 Jul. 30; all applications are incorporated by reference herein in their entirety.

### BACKGROUND

The invention is based on a centring ring according to the preamble of claim 1 and on a method for reducing the risk of breakage of at least one thin-walled area of a centring ring according to the preamble of claim 12. The invention is, in particular, based on a centring ring for handlebars of two-wheeled and three-wheeled vehicles which is integrated in a steering head bearing of the vehicle (a device used for coaxially mounting shafts within bores thus permitting to compensate for production-related diameter variations of the attachments and achieving a concentrical mounting of the components without play.

Centring rings for coaxially mounting fork shafts are state of the art. They create a rotatable connection between the bicycle frame and the fork. Centring rings according to the state of the art have a gap (slot) so as to be able to compensate tolerances of the attachments. This gap represents a weakening, since the centring ring, being an open C-shaped component, lacks the properties of a connected disc (a solid, disc-shaped O), which provides greater stability.

A common bearing arrangement is standardised according to a system known as the Standardised Headset Identification System (SHIS). This specification for the identification of modern threadless headsets (Ahead headsets), which use a claw mechanism instead of a fork shaft thread to adjust the bearing play, provides for three different installation positions (External Cup (EC), Zero Stack (ZS), Integrated Standard (IS)). While with the External Cup (EC) the bearing shells sit outside the head tube, with the Zero Stack (ZS) the bearing shells are pressed into the head tube, and with the Integrated Standard (IS) they are integrated directly into the head tube, so that the bearing shells are no longer visible from the outside. Centring rings can be employed in all three installation positions.

When an SHIS standardised headset is mounted according to the Integrated Standard (IS), rolling bearings, usually angular contact ball bearings, are inserted into a bicycle frame. The centring ring is inserted into the upper rolling bearing and then the fork is slid through the hole in the lower rolling bearing and then through the hole in the centring ring. The centring ring is used in the upper bearing as it is primarily the upper centring ring that must be free of play, since forces introduced by the handlebar will mainly be absorbed by the upper unit.

The state of the art also includes the centring rings disclosed in European patent application EP 1 721 820 A2, Japanese publication JP S56 13086 U, Spanish patent specification ES 2 166 263 B1 and in US specifications U.S. Pat. No. 10,050,490 B1 and U.S. Pat. No. 3,236,572 A.

Prior art centring rings solve the task of creating a rotatable connection between the bicycle frame, the fork and the rolling bearings. On modern bicycles, for example, brake lines, gear shift cables or electrical cables are routed internally, which is why the centring ring must have a suitable accommodation recess. A centring ring of this type is disclosed in the published application DE 10 2020 102 826 A1 and in the published application DE 10 2015 202 383 A1. The centring rings for modern bicycles therefore differ from conventional centring rings.

To enable a cable feed-through in a centring ring, the centring ring must have additional features: for one thing, it needs to have a high wall thickness that must be at least equal to the cable thickness to be fed through and, for another, a cable entry opening must be provided. This results in mechanically weakened sections on the centring ring, as there will be structurally thin-walled regions (thin-walled segments) in the area of the cable routing. These thin-walled areas can break during operation, since wobble forces occurring during the operation of the two-wheeled vehicle will lead to tensile and compressive forces within the centring ring. In addition, the thin-walled areas can be damaged during assembly, as the centring ring is generally not very stress-resistant due to this weakening. Neither transport damage nor damage caused by negligent installation can therefore be ruled out. In addition, a centring ring according to the state of the art has a gap (slot) that enables tolerance compensation during assembly. This further increases the risk of damage during transport or installation. One possible solution for stabilising the centring ring and thus reducing the risk of damage during transport, assembly or use would be to either increase the wall thickness in the weakened areas or to omit the gap. Omitting the gap, however, would mean that tolerance compensation is no longer possible. Increasing the wall thicknesses is not possible from a practical point of view, as any increase in the wall thickness would be tantamount to increasing the diameter of the head tube.

### SUMMARY

It is therefore an object of the invention to provide a centring ring that overcomes the disadvantages of the state of the art and to provide a method for reducing the risk of breakage of at least one thin-walled area of a centring ring which overcomes the disadvantages of the state of the art.

### DETAILED DESCRIPTION

The centring ring according to the invention including the features of claim 1 and the method according to the invention for reducing the risk of breakage of at least one thin-walled area of a centring ring including the features of claim 12 have the advantage, in contrast, that the centring ring has at least two thick-walled segments, i.e. at least one first thick-walled segment and one second thick-walled segment, said first thick-walled segment having a side surface which faces a side surface of the second thick-walled segment, said side surfaces having a gap arranged therebetween which has a given clearance, said clearance being variable between a minimum clearance and a maximum clearance, said side surfaces touching each other at least partially or being separated from each other by the gap having a given clearance, and said centring ring including at least one movement limiter which has at least one contact surface and/or one end face and which allows the side surfaces to merely drift apart under the application of force until the maximum clearance is reached and/or which allows the side surfaces to merely drift towards each other under the application of force until the minimum clearance is reached. Such a drifting movement, either apart from each other or towards each other, occurs in particular when the side surfaces of the first and second thick-walled segments move away from each other or towards each other in a radial direction and/or when the side surfaces of the first and second thick-walled segments move relative to each other, in particular in an axial direction, from a position facing each other to a position in which they face each other only at least partially, or from a position in which they face each other only at least partially to a position facing each other.

When a certain clearance is reached, the clearance-changing movement(s) is/are decelerated or stopped.

Since the two facing side surfaces of the first thick-walled segment and the second thick-walled segment touch each other or are spaced apart by a gap, the centring ring according to the invention can compensate diameter variations of the attachments. In addition, the centring ring of the invention offers the possibility of routing cables therethrough. In order to at least minimise, if not eliminate, the risk of damage associated with tolerance compensation and a cable feed-through, for example during transport, assembly or use, the centring ring of the invention has at least one movement limiter (connecting member), by means of which the centring ring of the invention is stabilised, thus ensuring, for example, damage-free transport, damage-free assembly and long-lasting use of the centring ring of the invention without any risk of breakage. To ensure this, the centring ring according to the invention is capable of adapting to production-related diameter variations of the connecting components. This radial widening of the C-shaped centring ring which is required for this purpose is, however, limited by at least one movement limiter in such a way that when the gap is maximally widened to a given clearance (maximum clearance) or when it is maximally narrowed to a given clearance (minimum clearance, which in extreme cases means that the facing side surfaces of the thick-walled segments will touch), at least one movement limiter establishes a transmission of force between two thick-walled segments of the centring ring according to the invention. This means that tensile and compressive forces caused by wobbling forces between the thick-walled segments of the centring ring of the invention will no longer have any destructive effect on a thin-walled area (thin-walled segment) of the centring ring, as the latter is compressed, should the occasion arise, only by a minimum amount. Due to the at least one movement limiter, the centring ring of the invention is no longer an open, C-shaped component, as is known from the prior art, but corresponds in its geometric shape to a closed, disc-shaped O, despite the gap or despite the touching side surfaces of the thick-walled segments. The at least one movement limiter has the additional advantage that the centring ring of the invention, which can be used in all three SHIS installation positions, is inherently stable, for example during handling, transport, and assembly, so that it cannot be damaged already before assembly, as may be the case, for example, with prior art centring rings, and possibly even be installed in a damaged condition.

According to an advantageous configuration of the centring ring of the invention, said side surface is arranged on the end face of the first thick-walled segment and/or said side surface is arranged on the end face of the second thick-walled segment.

According to an additional advantageous configuration of the centring ring of the invention, at least one movement limiter is arranged on the side surface of the first thick-walled segment and/or at least one movement limiter is arranged on the side surface of the second thick-walled segment and/or at least one movement limiter constitutes a separate component.

According to an additional advantageous configuration of the centring ring of the invention, at least one thick-walled segment has at least one contact surface for at least one movement limiter.

According to a pertinent advantageous configuration of the centring ring of the invention, at least one contact surface is arranged in a cavity formed within a thick-walled segment.

According to an additional advantageous configuration of the centring ring of the invention, a tongue-and-groove connection is formed between a movement limiter and a thick-walled segment by the movement limiter having at least one groove arranged thereon and the thick-walled segment having at least one corresponding tongue arranged thereon, and/or by the movement limiter having at least one tongue arranged thereon and the thick-walled segment having at least one corresponding groove arranged thereon. Due to the tongue-and-groove connection, the movement limiter is suitable for stabilising the centring ring of the invention when force is applied in an axial direction, thereby preventing damage in the event of improper handling.

According to an additional advantageous configuration of the centring ring of the invention, a tongue-and-groove connection is formed between one movement limiter and another movement limiter by the one movement limiter having at least one groove arranged thereon and the other movement limiter having at least one corresponding tongue arranged thereon, and/or a tongue-and-groove connection is formed between one movement limiter and another movement limiter by the one movement limiter having at least one groove arranged thereon and the other movement limiter having at least one corresponding tongue arranged thereon.

According to an additional advantageous configuration of the centring ring of the invention, the centring ring has a first thin-walled segment and a second thin-walled segment, said first thin-walled segment being arranged adjacent to the first thick-walled segment and said second thin-walled segment being arranged adjacent to the second thick-walled segment.

According to a pertinent advantageous configuration of the centring ring of the invention, a thick-walled segment, i.e. a third thick-walled segment, is arranged between the first thin-walled segment and the second thin-walled segment.

According to an additional advantageous configuration of the centring ring of the invention, one of the thick-walled segments has a connection bore. This makes it possible to fix a thick-walled segment, in particular by fastening it to the stem.

According to an additional advantageous configuration of the centring ring of the invention, at least one thin-walled segment is in the form of a cable feed-through The cable feed-through makes it possible to route electrical cables, mechanical cables and/or hydraulic lines in a protected manner inside the frame.

According to an advantageous configuration of the method of the invention for reducing the risk of breakage of at least one thin-walled segment of a centring ring, said centring ring having at least two thick-walled segments, i.e. at least one first thick-walled segment and one second thick-walled segment, said first thick-walled segment having a side surface which faces a side surface of the second thick-walled segment, said side surfaces having a gap arranged therebetween which has a given clearance, said clearance being variable between a minimum clearance and a maximum clearance, said side surfaces touching each other at least partially or being separated from each other by the gap having a given clearance, and said centring ring including at least one movement limiter which has at least one contact surface and/or one end face and which allows the side surfaces to merely drift apart under the application of force until the maximum clearance is reached and/or which allows the side surfaces to merely drift towards each other under the application of force until the minimum clearance is reached, a drifting apart of the side surfaces under the application of force and/or their drifting towards each other under the application of force is decelerated or stopped as soon as at least one contact surface of the movement limiter comes into contact with at least one contact surface arranged on a thick-walled segment or as soon as the end face of the movement limiter comes into contact with at least one contact surface which is arranged in a cavity formed within a thick-walled segment.

According to an additional advantageous configuration of the method of the invention, at least one of the movement limiters has at least two contact surfaces, i.e. a first contact surface and a second contact surface, so that a drifting apart of the side surfaces under the application of force and/or their drifting towards each other under the application of force is decelerated or stopped as soon as the first contact surface of the movement limiter comes into contact with at least one contact surface arranged on a first thick-walled segment and the second contact surface of the movement limiter comes into contact with at least one contact surface arranged on a second thick-walled segment.

According to an additional advantageous configuration of the method of the invention, at least one of the movement limiters has at least two contact surfaces, i.e. a first contact surface and a second contact surface, so that a drifting apart of the side surfaces under the application of force and/or their drifting towards each other under the application of force is decelerated or stopped as soon as the first contact surface of the movement limiter comes into contact with at least one contact surface arranged on a thick-walled segment and the second contact surface of the movement limiter comes into contact with a contact surface arranged on a second movement limiter.

According to an additional advantageous configuration of the method of the invention, at least one of the movement limiters has at least one contact surface, so that a drifting apart of the side surfaces under the application of force and/or their drifting towards each other under the application of force is decelerated or stopped as soon as at least one contact surface of the movement limiter comes into contact with at least one contact surface arranged on a second movement limiter.

According to an additional advantageous configuration of the method of the invention, a transmission of forces between two thick-walled segments of the centring ring is established at the latest when the given clearance as specified by the movement limiter(s) is reached.

According to an additional advantageous configuration of the method of the invention, the centring ring is used in a steering head bearing of a vehicle.

According to an additional advantageous configuration of the method of the invention, the centring ring employed is a centring ring as claimed in any one of claims 1 to 11.

Further advantages and advantageous configurations of the invention may be found in the following description and in the drawings.

### BRIEF DESCRIPTION OF THE DRAWINGS

Preferred embodiment examples of the object of the invention are represented in the drawings and will be described hereunder in greater detail. In the drawings:

FIG. 1 is an isometric exploded representation of a steering head bearing,

FIG. 2 is sectional view of the upper part of a steering head bearing,

FIG. 3 is a perspective sectional drawing of an upper bearing,

FIG. 4 is another perspective sectional drawing of an upper bearing,

FIG. 5 is a side sectional view of an upper bearing,

FIG. 6 is a detail A of FIG. 5,

FIG. 7 is a perspective representation of a centring ring of the invention in a non-mounted state,

FIG. 8 is another perspective representation of the centring ring of the invention as shown in FIG. 7,

FIG. 9 is a top view of the centring ring of the invention as shown in FIG. 7,

FIG. 10 is a sectional view of the centring ring of the invention as shown in FIG. 9,

FIG. 11 is a perspective representation of a centring ring of the invention in an assembled state,

FIG. 12 is a top view of the centring ring of the invention as shown in FIG. 11,

FIG. 13 is a sectional view of the centring ring of the invention as shown in FIG. 12,

FIG. 14 is a detail C of FIG. 13,

FIG. 15 is a top view of the upper bearing according to FIG. 3 shown in section and in a relieved state,

FIG. 16 is a top view of the upper bearing according to FIG. 3 shown in section and in a loaded state,

FIG. 17 is a top view of the upper bearing according to FIG. 16 shown in section and in the loaded state, with the compression being represented in an exaggerated manner,

FIG. 18 is the top view of the upper bearing according to FIG. 16 shown in section and in the loaded state and including the line E-E,

FIG. 19 is a lateral sectional drawing according to line E-E in FIG. 18,

FIG. 20 is a sectional view of another embodiment example of a centring ring of the invention,

FIG. 21 is a sectional view of a further embodiment example of a centring ring of the invention,

FIG. 22 is a sectional view of a further embodiment example of a movement limiter of a centring ring of the invention,

FIG. 23 is a sectional view of a further embodiment example of a movement limiter of a centring ring of the invention,

FIG. 24 is a sectional view of a further embodiment example of a centring ring of the invention.

### DETAILED DESCRIPTION OF THE PREFERRED EMBODIMENTS

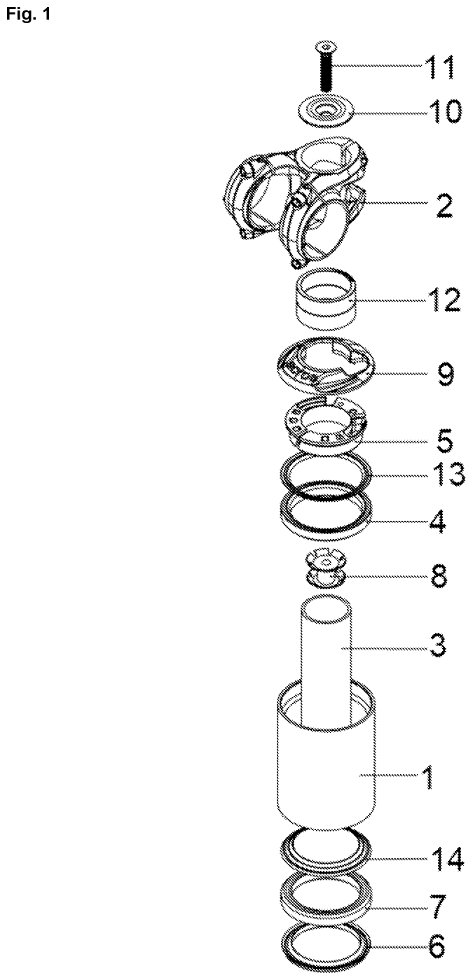

FIG. 1 is an isometric exploded representation of a steering head bearing. The steering head bearing is installed in a head tube 1 of a non-illustrated frame of a vehicle and consists in a known manner of an upper steering head bearing arranged below a handlebar stem 2 of a handlebar of the vehicle in the head tube 1, and of a lower steering head bearing arranged above the equally non-illustrated fork and fork shaft 3 of the vehicle. The upper steering head bearing has an upper bearing shell with an upper bearing 4 (upper rolling bearing) which is mounted within the head tube 1 by means of a centring ring 5 (clamping ring) according to the invention. The lower steering head bearing consists of a base 6 struck onto the fork shaft 3, a lower bearing 7 (lower rolling bearing) supported by the base 6, and a lower bearing shell into which the lower bearing 7 and outer ring are pressed. The lower bearing shell is pressed into the lower opening of the head tube 1. The fork shaft 3 is passed through an inner ring of the lower bearing 7 and through the inner ring of the upper bearing 4 and protrudes right into the upper centring ring 5 of the invention. A clamping claw 8 is struck into the upper opening of the fork shaft 3 and transmits the steering torque applied by the bicycle rider onto the handlebar of the vehicle to the fork via the handlebar stem 2. For the sake of completeness, FIG. 1 also represents the other parts that connect the handlebar stem 2 to the fork and the head tube 1: the head tube 1 is covered by means of a cover 9 (spacer). The handlebar stem 2 is fixedly connected to the fork shaft 3 and is co-rotationally, and without play, connected to the head tube 1 by means of a clamping cover 10 and a setting screw 11. In addition, spacer rings 12, which allow the handlebar stem 2 to be arranged at a given distance, an upper sealing ring 13, and a lower sealing ring 14 are used.

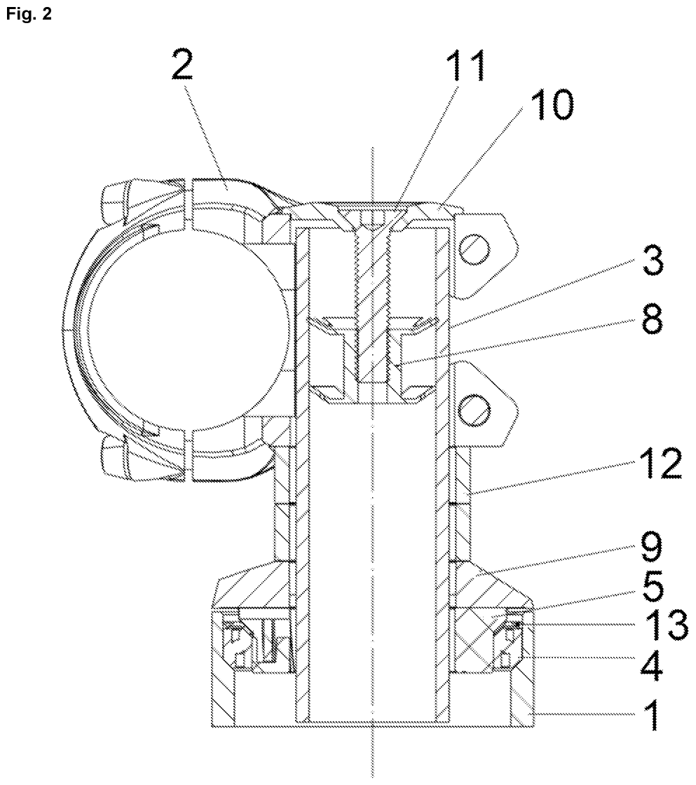

FIG. 2 is a sectional view of the upper part of a steering head bearing.

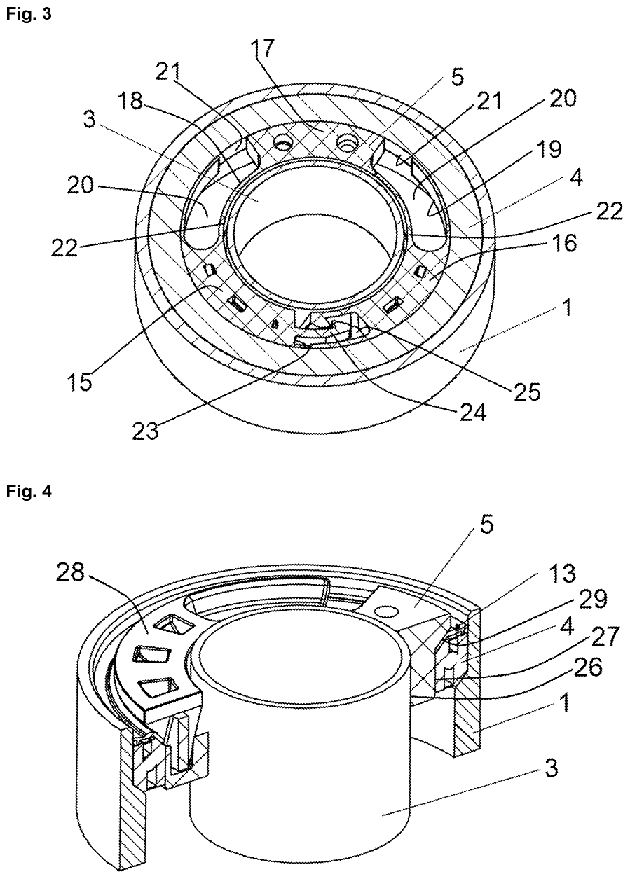

FIG. 3 is a perspective sectional drawing of an upper bearing 4. In this embodiment example, the centring ring 5 of the invention has three thick-walled segments, i.e. a first thick-walled segment 15, a second thick-walled segment 16, and a third thick-walled segment 17. A first thin-walled segment 18 is arranged between the first thick-walled segment 15 and the third thick-walled segment 17. A second thin-walled segment 19 is located between the second thick-walled segment 16 and the third thick-walled segment 17. The thin-walled segments 18 and 19 are designed as cable feed-throughs 20, which have a cable entry opening 21 and a connecting element 22, so that cables can be routed within the vehicle frame. It is also conceivable that the thin-walled design of a thin-walled segment serves merely the purpose of weight reduction. One side surface 23 of the first thick-walled segment 15, which in the present case is designed as an end face, has a movement limiter 24 arranged thereon. In the assembled state or, as shown here in the installed state, of the centring ring 5 of the invention, the movement limiter 24 projects into a cavity 25 arranged within the second thick-walled segment 16.

FIG. 4 is another perspective sectional drawing of an upper bearing 4. The centring ring 5 of the invention has an inner lateral surface 26, which faces the fork shaft 3, an outer lateral surface 27, which faces the upper bearing 4 (upper rolling bearing), a frontal, upper contact surface 28, which faces the cover 9, and an inclined contact surface 29, which adjoins the outer lateral surface 27. When in use, the centring ring 5 of the invention is subjected to both radial forces and axial forces, acting in conjunction on said centring ring 5 of the invention. The radially acting forces are forces that act on the inner lateral surface 26 and on the outer lateral surface 27. A radially acting force is an operating force introduced by a braking process or an operating force introduced by driving over obstacles. The axially acting forces are forces that act on the frontal, upper contact surface 28 and on the inclined contact surface 29. Axially acting forces are internal forces introduced by the axial pre-tensioning force of the headset, resulting axial forces or wobbling forces caused by the bending of the fork and acting between the thick-walled segments, i.e., in the embodiment example shown, between the first thick-walled segment 15, the second thick-walled segment 16, and the third thick-walled segment 17.

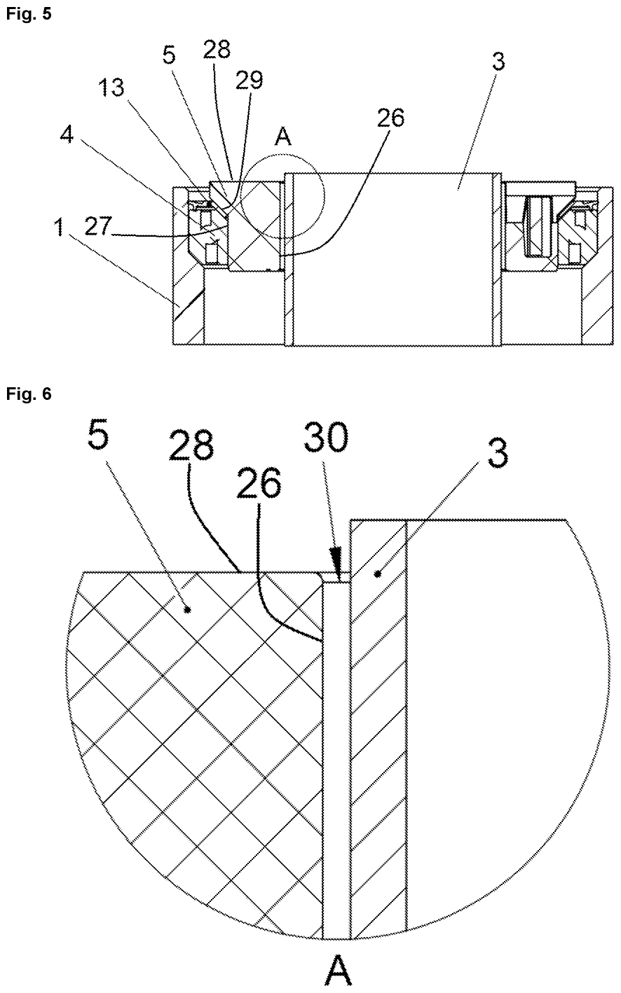

FIG. 5 is a side sectional view of an upper bearing 4.

FIG. 6 is a detail A of FIG. 5. The centring ring 5 of the invention and the fork shaft 3 have a gap 30 positioned therebetween. The gap 30 is compensated by the functionality of the centring ring 5 of the invention, so that there is no play between the individual components, i.e. the rolling bearing, the centring ring 5 of the invention, and the fork shaft 3.

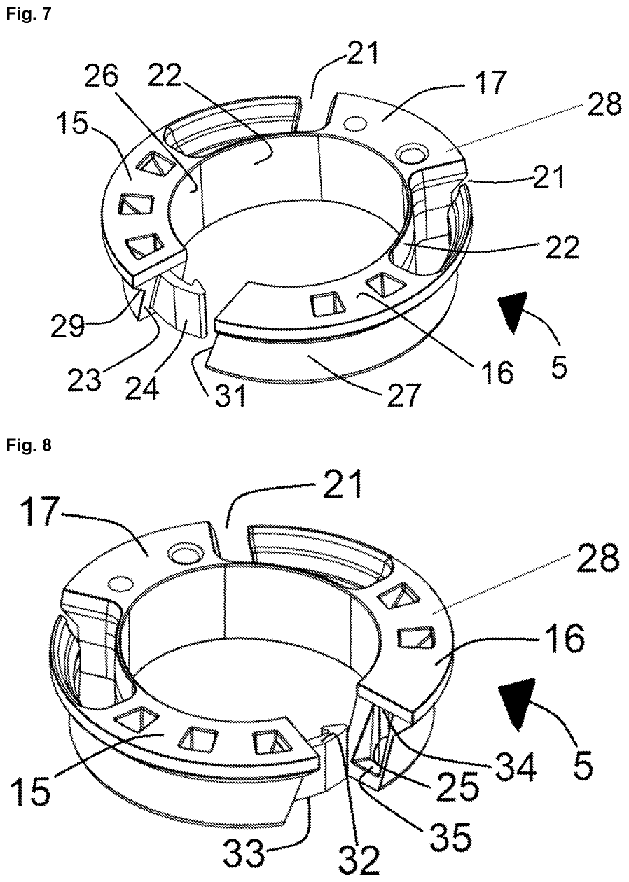

FIG. 7 is a perspective representation of a centring ring 5 of the invention in a non-mounted state. In the non-mounted state, the centring ring 5 of the invention can be widened, whereby the movement limiter 24 is located outside the cavity arranged in the second thick-walled segment 16, which is located on one side surface 31.

FIG. 8 is another perspective representation of the centring ring 5 of the invention as shown in FIG. 7. The movement limiter 24, which may be slightly resilient, has contact surfaces 32 and 33. When the movement limiter 24, disposed in the assembled state or in a mounted state, is located at least partially within the cavity 25, the contact surface 32 can be operatively connected, or be brought into operative connection, with a contact surface 34 arranged in the cavity 25. Alternatively or in addition, when the movement limiter 24, disposed in the assembled state or in a mounted state, is located at least partially within the cavity 25, the contact surface 33 can be operatively connected, or be brought into operative connection, with a contact surface 35 arranged in the cavity 25. The movement limiter 24 is thus suitable for stabilising the centring ring 5 of the invention when force is applied in an axial direction, thereby preventing damage in the event of improper handling.

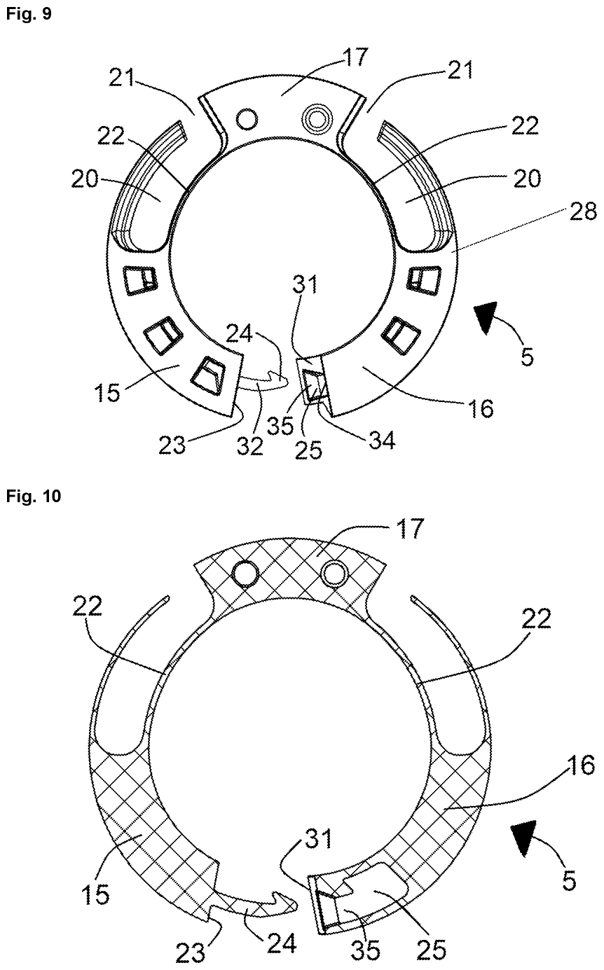

FIG. 9 is a top view of the centring ring 5 of the invention as shown in FIG. 7.

FIG. 10 is a sectional view of the centring ring 5 of the invention as shown in FIG. 9.

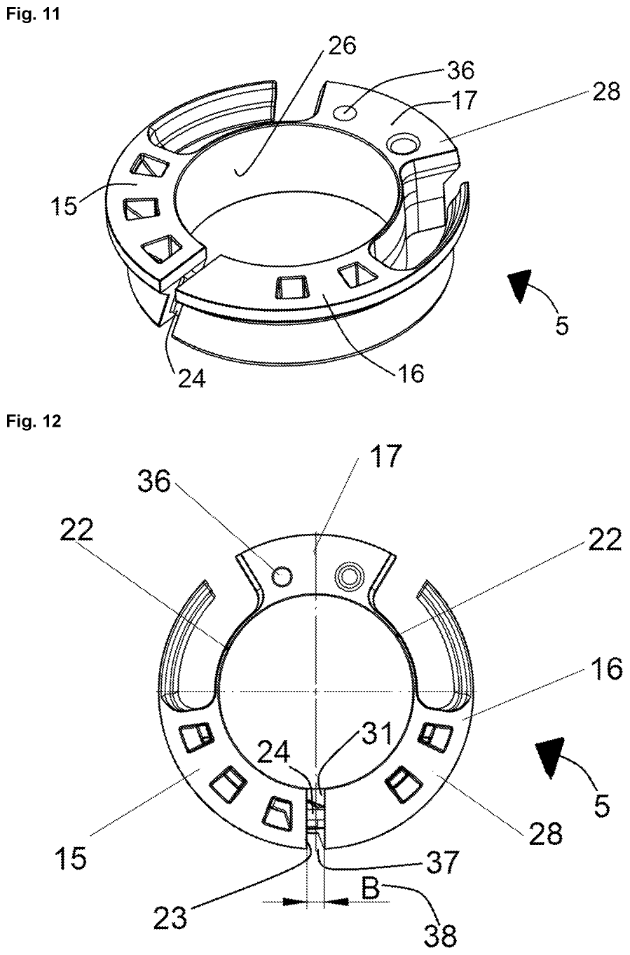

FIG. 11 is a perspective representation of a centring ring 5 of the invention in an assembled state. In the assembled state, as well as in the mounted state, the movement limiter 24 is located within the cavity arranged in the second thick-walled segment 16. A connection bore 36 enables a thick-walled segment to be affixed, thus creating a rigid connection with the stem. To establish the rigid connection, a pin, which is arranged on a side of the cover 9 facing the centring ring 5 of the invention, is preferably inserted into the connection bore 36. In this embodiment example, the third thick-walled segment 17 is affixed.

FIG. 12 is a top view of the centring ring 5 of the invention as shown in FIG. 11. The side surface 23 of the first thick-walled segment 15 and the side surface 31 of the second thick-walled segment 16 have a gap 37 formed therebetween, which has a clearance X 38. It is also conceivable that the side surfaces 23 and 31 touch each other when they are in their assembled or mounted state.

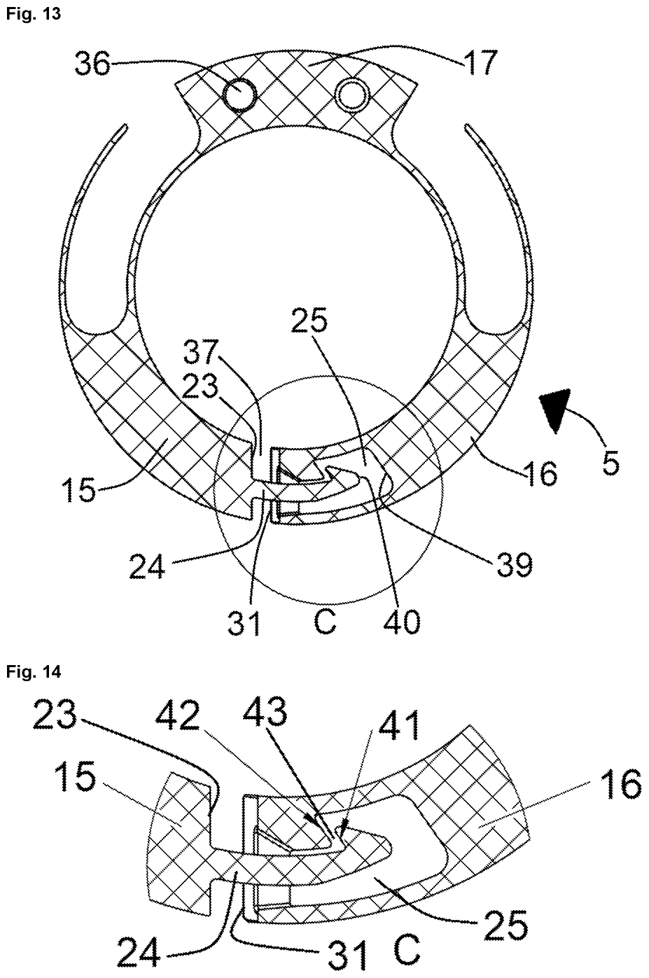

FIG. 13 is a sectional view of the centring ring 5 of the invention as shown in FIG. 12. The cavity 25 has a contact surface 39 which, if the movement limiter 24 comprising an end face 40 is long enough, serves as a stop for the end face 40 in order to decelerate or stop an anti-clockwise rotational movement resulting from the application of force to the first thick-walled segment 15 and/or a clockwise rotational movement resulting from the application of force to the second thick-walled segment 16. This leaves a minimum gap between the first thick-walled segment 15 and the second thick-walled segment 16, which, depending on the design of the movement limiter 24, has a clearance 38 of ≥0 mm. The minimum gap with a clearance 38 of 0 mm is achieved when the side surfaces 23 and 31 touch each other before, or during, the establishment of contact between the end face 40 and the contact surface 39, such that the rotational movement of the first thick-walled segment 15 and/or the second thick-walled segment 16 is additionally decelerated or stopped by this contact. The minimum gap with a clearance 38 of >0 mm is achieved when the side surfaces 23 and 31 do not touch each other before, or during, the establishment of contact between the end face 40 and the contact surface 39.

FIG. 14 is a detail C of FIG. 13. The movement limiter 24 has a contact surface 41 which can be brought into operative connection with a contact surface 42 arranged on the cavity 25 in the event of a rotational movement in a clockwise direction, under the application of force, to the first thick-walled segment 15 and/or in the event of a rotational movement in an anti-clockwise direction, under the application of force, to the second thick-walled segment 16, whereby said rotational movement is decelerated or stopped. In the relieved state, i.e. when no forces, in particular no wobbling forces, which lead to tensile and compressive forces between the first thick-walled segment 15, the second thick-walled segment 16, and/or the third thick-walled segment 17, act on the centring ring 5 of the invention, a gap 43 is arranged between the contact surfaces 41 and 42.

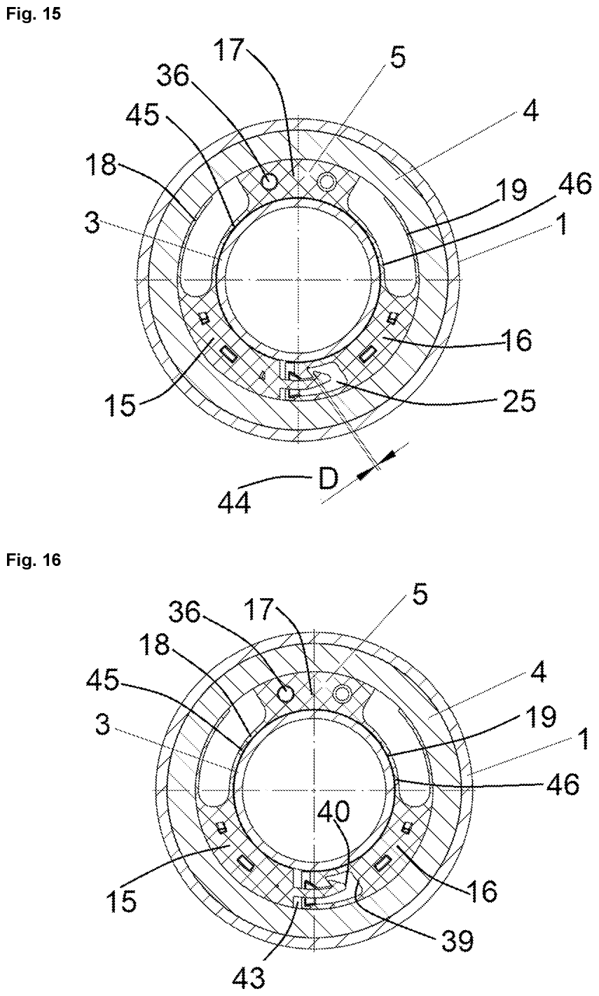

FIG. 15 is a top view of the upper bearing 4 according to FIG. 3 shown in section and in a relieved state. The gap 43 arranged between the contact surfaces 41 and 42 has a clearance D 44. The first thin-walled segment 18 has a first connecting element 45 and the second thin-walled segment 19 has a first connecting element 46.

FIG. 16 is a top view of the upper bearing 4 according to FIG. 3 shown in section and in a loaded state. In the relieved state, i.e. when no forces, in particular no wobbling forces, which lead to tensile and compressive forces between the first thick-walled segment 15, the second thick-walled segment 16, and/or the third thick-walled segment 17, act on the centring ring 5 of the invention, the clearance D 44 and the clearance B 38 will change. Increasing the clearance D 44 causes the clearance B 38 to become smaller and decreasing the clearance D 44 causes the clearance B 38 to become larger. When the contact surfaces 41 and 42 touch, the gap 37 reaches its maximum clearance. When the end face 40 and contact surface 39 touch, the gap 43 reaches its maximum clearance.

The effect of forces, in particular wobbling forces, for example, causes the first thick-walled segment 15 to experience a circular force urging it towards the third thick-walled segment 17. This operating force leads to compression of the first connecting element 45 arranged therebetween and, in the case of prior art centring rings, ultimately to breakage of at least one connecting element, since the compression results in excessive stress and strain. In contrast, tensile forces acting on a connecting element 22 will not pose a problem, as these forces occurring during driving are below the load limit.

The centring ring 5 of the invention solves this problem by allowing only a limited rotational movement between the first thick-walled segment 15 and the second thick-walled segment 16. The free movement of the two thick-walled segments with respect to each other corresponds to the distance required to compensate for usual tolerance deviations of the connecting parts.

If, for example, wobbling forces occur during operation which lead to excessive compression of one connecting element 22 or of both connecting elements 22, the two thick-walled segments engage with each other and become operatively connected, whereby a tensile force can be transmitted between the first thick-walled segment 15 and the second thick-walled segment 16. This prevents the connecting element 22 or the connecting elements 22 from experiencing excessive stress and strain, since the two thick-walled segments are restricted in their ability to move relative to each other. As a result, the third thick-walled segment 17 and the connecting element 22 and/or the connecting elements 22 are not compressed, which means that the centring ring 5 of the invention will not be damaged.

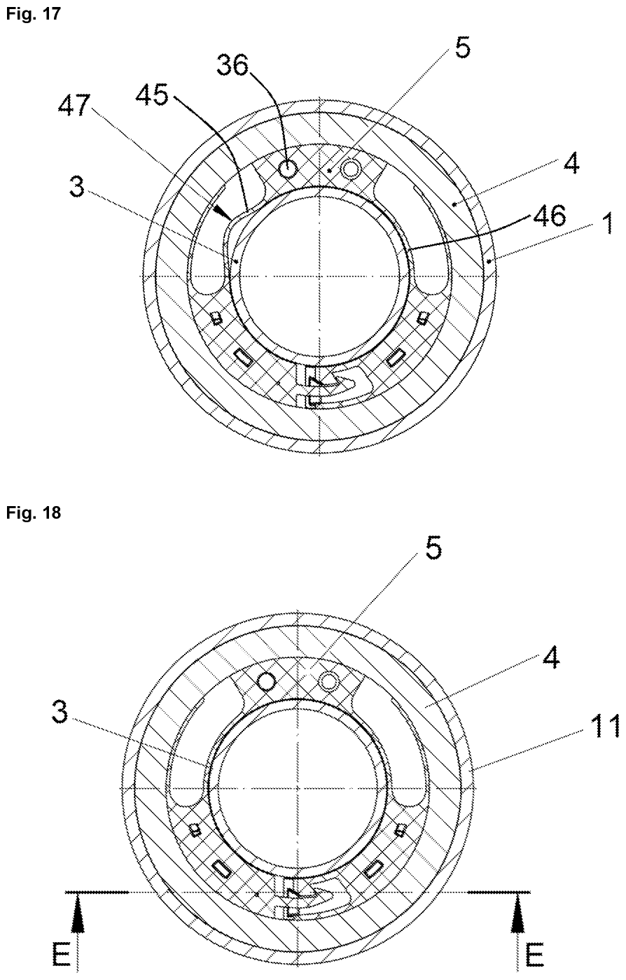

FIG. 17 is a top view of the upper bearing 4 according to FIG. 16 shown in section and in the loaded state, with a compression 47 being represented in an exaggerated manner. Due to the connection bore 36, the third thick-walled segment 17 is connected in a rotationally fixed manner to the handlebar stem 3. If, for example, a wobbling force leads to a circular movement of the first thick-walled segment 15 in a clockwise direction, the first thick-walled segment 15 will move towards the third thick-walled segment 17. The first connecting element 45 is arranged between the first thick-walled segment 15 and the third thick-walled segment 17. The first thick-walled segment 15 is operatively connected to the second thick-walled segment 16, thus enabling the transmission of tensile forces. Since the second thick-walled segment 16 is operatively connected to the third thick-walled segment 17 via the second connecting element 46, tensile forces may be transmitted therebetween. There is an equilibrium of forces. A potentially damaging wobbling force acting on the first thick-walled segment 15 will thus not cause breakage of the first connecting element 45 of the first thin-walled segment 18. At most, the first connecting element 45 will only be slightly compressed.

FIG. 18 is the top view of the upper bearing 4 according to FIG. 16 shown in section and in the loaded state and including the line E-E.

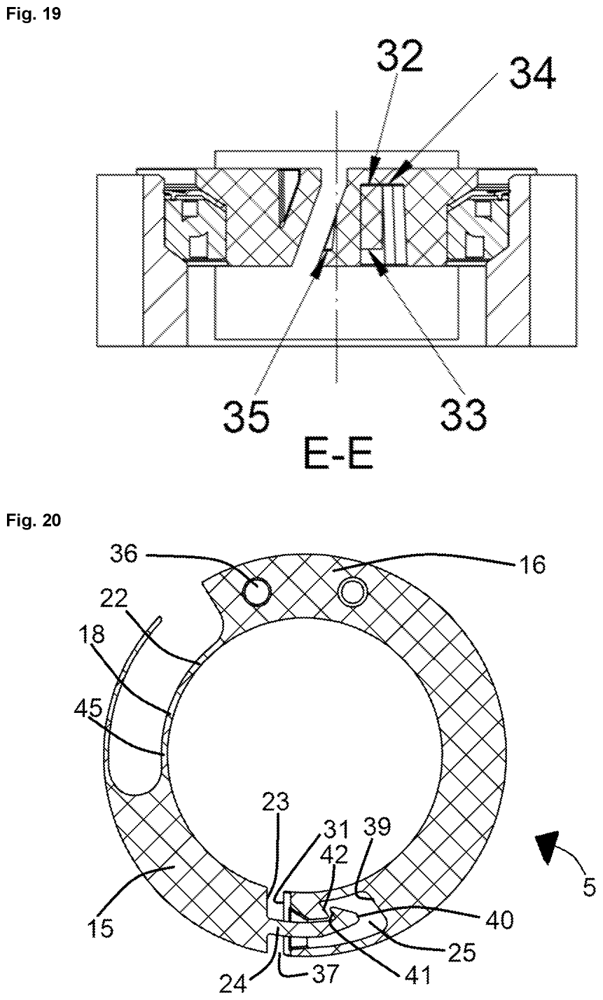

FIG. 19 is a lateral sectional drawing according to line E-E in FIG. 18.

FIG. 20 is a sectional view of a further embodiment example of a centring ring 5 of the invention. Unlike the centring ring 5 of the invention shown in FIG. 13, the centring ring 5 of the invention shown in FIG. 20 has only one thin-walled segment, i.e. the first thin-walled segment 18, and only two thick-walled segments, i.e. the first thick-walled segment 15 and the second thick-walled segment 16. In this embodiment example, the second thick-walled segment 16 is affixed to the handlebar stem 2 by means of the connection bore 36.

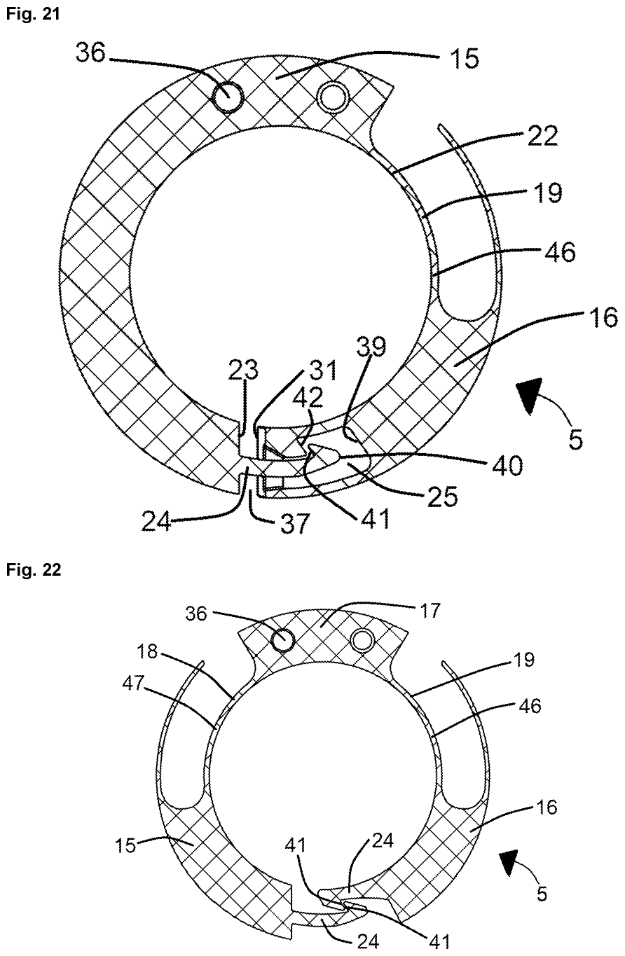

FIG. 21 is a sectional view of a further embodiment example of a centring ring 5 of the invention. Unlike the centring ring 5 of the invention shown in FIG. 13, the centring ring 5 of the invention shown in FIG. 21 has only one thin-walled segment, i.e. the second thin-walled segment 19, and only two thick-walled segments, i.e. the first thick-walled segment 15 and the second thick-walled segment 16. In this embodiment example, the first thick-walled segment 15 is affixed to the handlebar stem 2 by means of the connection bore 36.

FIG. 22 is a sectional view of a further embodiment example of a centring ring 5 of the invention. Unlike the previously shown embodiment examples, the centring ring 5 of the invention has two movement limiters 24 whose respective contact surfaces 41 can be brought into operative connection with each other in order to decelerate or stop a rotational movement of a thick-walled segment or several thick-walled segments. It is also conceivable that such an embodiment example is equipped with only one thin-walled segment. It is also conceivable that a tongue-and-groove connection is arranged between the movement limiters 24, which is suitable for stabilising the centring ring 5 of the invention when a force is applied in the axial direction, thereby preventing damage in the event of improper handling.

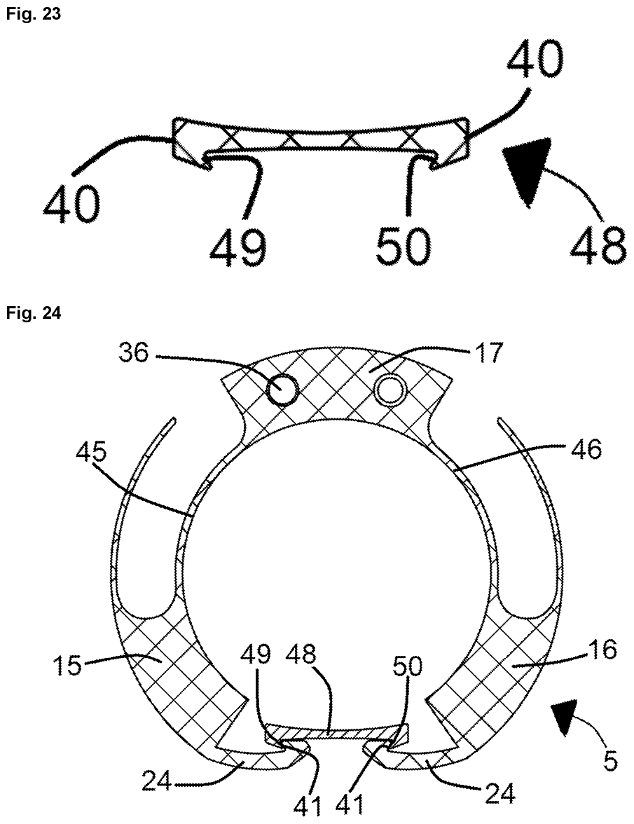

FIG. 23 is a sectional view of a further embodiment example of a movement limiter 48 of a centring ring 5 of the invention. In this case, the movement limiter 48 is designed as a separate component which has contact surfaces 49 and 50, by means of which the movement limiter 48 can be brought into operative connection with contact surfaces 42 arranged on thick-walled segments and/or with contact surfaces arranged on other movement limiters 24, i.e. the contact surfaces 41, 49 or 50, and/or with contact surfaces arranged on other movement limiters 48, i.e. the contact surfaces 49 or 50. In addition, the movement limiter 48 has end faces 40 through which the movement limiter 48 can be brought into operative connection with contact surfaces 39 arranged on thick-walled segments.

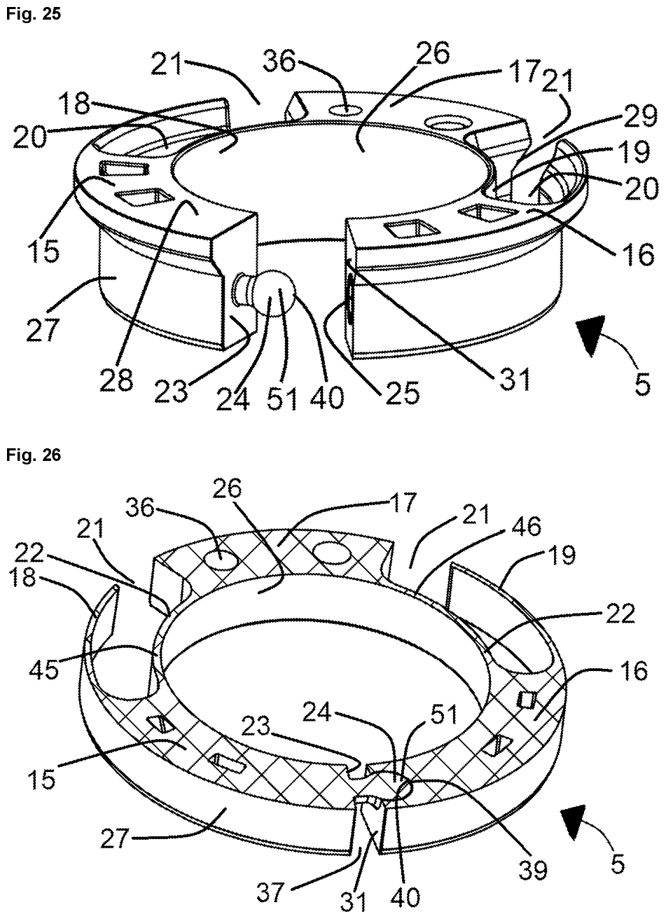

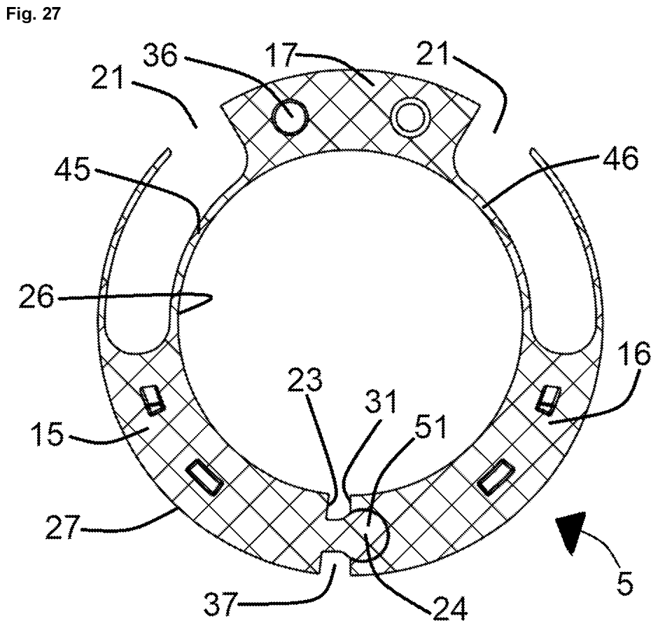

FIG. 24 is a sectional view of a further embodiment example of a centring ring 5 of the invention. The centring ring 5 of the invention has three movement limiters, i.e. two movement limiters 24 and one movement limiter 48, with one movement limiter 24 being arranged on the thick-walled segment 15 and one movement limiter 24 being arranged on the thick-walled segment 16 and the third movement limiter 48 being designed as a separate component which has contact surfaces 49 and 50 by means of which the movement limiter 48 can be brought into operative connection with the contact surfaces arranged on the other movement limiters 24, i.e. the contact surfaces 41, in order to decelerate or stop a rotational movement of a thick-walled segment or a plurality of thick-walled segments.

It is also conceivable that such an embodiment example is equipped with only one thin-walled segment. It is further conceivable that a tongue-and-groove connection is arranged between the movement limiters 24 and 48, which is suitable for stabilising the centring ring 5 of the invention when a force is applied in the axial direction, thereby preventing damage in the event of improper handling. It is additionally conceivable that only one movement limiter 24 arranged on a thick-walled segment is used and that the movement limiter 48, designed as a separate component, projects with one end into a cavity arranged on another thick-walled segment, whereby its contact surface 49 or 50 can be brought into operative connection with a contact surface 42 arranged in said cavity or whereby its end face 40 can be brought into operative connection with a contact surface 39 arranged in said cavity.

FIG. 25 is a perspective representation of a further embodiment example of a centring ring 5 of the invention in a non-mounted state. In the non-mounted state, the centring ring 5 of the invention can be widened, whereby the movement limiter 24 is located outside the cavity 25 arranged in the second thick-walled segment 16, which is located on one side surface 31. Unlike the centring ring 5 of the invention shown in FIG. 7, the movement limiter 24 of the invention shown in FIG. 25 does not have a locking hook but a ball head 51. It would also be conceivable to have other geometric shapes of the movement limiter 24, which may have contact surfaces that can be brought into operative connection with contact surfaces arranged within the cavity 25, whereby a potentially damaging application of force to one or more thick-walled segments will not result in the breakage of a thin-walled segment. In the assembled state, as well as in the mounted state, the movement limiter 24 is located within the cavity 25 arranged in the second thick-walled segment 16. It is also conceivable that such an embodiment example is equipped with only one thin-walled segment, which would eliminate the need for the third thick-walled segment 17.

FIG. 26 is a sectional view of the centring ring 5 of the invention according to FIG. 25 as shown in an assembled state. A connection bore 36 enables a thick-walled segment to be affixed, thus creating a rigid connection with the stem. To establish the rigid connection, a pin, which is arranged on a side of the cover 9 facing the centring ring 5 of the invention, is preferably inserted into the connection bore 36. In this embodiment example, the third thick-walled segment 17 is affixed. It is also conceivable that the side surfaces 23 and 31 touch each other in their assembled or mounted state, such that there is no gap 37. The cavity 25 has a contact surface 39 which, if the movement limiter 24 comprising an end face 40 is long enough, serves as a stop for the end face 40 in order to decelerate or stop an anti-clockwise rotational movement resulting from the application of force to the first thick-walled segment 15 and/or a clockwise rotational movement resulting from the application of force to the second thick-walled segment 16.

FIG. 27 is a top view of the centring ring 5 of the invention as shown in FIG. 26. The side surface 23 of the first thick-walled segment 15 and the side surface 31 of the second thick-walled segment 16 have a gap 37 formed therebetween, which has a clearance X 38. It is also conceivable that the side surfaces 23 and 31 touch each other when they are in their assembled or mounted state.

All of the characteristics represented in the description, in the following claims and in the drawings, as considered either in themselves or in any combination with each other, may be deemed essential to the invention.

### LIST OF REFERENCE NUMERALS

1 head tube (bicycle frame)
2 handlebar stem
3 fork shaft
4 upper bearing
5 centring ring (clamping ring)
6 base
7 lower bearing
8 clamping claw
9 cover
10 clamping cover
11 setting screw
12 spacer ring
13 upper sealing ring
14 lower sealing ring
15 first thick-walled segment
16 second thick-walled segment
17 third thick-walled segment
18 first thin-walled segment
19 second thin-walled segment
20 cable feed-through
21 cable entry opening
22 connecting element
23 side surface
24 movement limiter
25 cavity
26 inner lateral surface
27 outer lateral surface
28 upper contact surface
29 inclined contact surface
30 gap
31 side surface
32 contact surface
33 contact surface
34 contact surface
35 contact surface
36 connection bore
37 gap
38 clearance B
39 contact surface
40 end face
41 contact surface
42 contact surface
43 gap
44 clearance D
45 first connecting element
46 second connecting element
47 compression
48 movement limiter
49 contact surface
50 contact surface
51 ball head

1. A centring ring (5) for two-wheeled and three-wheeled vehicles,
having at least two thick-walled segments, i.e. at least one first thick-walled segment (15) and one second thick-walled segment (16), said first thick-walled segment (15) having a side surface (23) facing a side surface (31) of said second thick-walled segment (16),
having at least one thin-walled segment which adjoins the first thick-walled segment (15) and/or the second thick-walled segment (16),
characterised in that
said side surfaces (23, 31) have a gap (37) arranged therebetween which has a given clearance B (38), wherein said clearance B (38) is variable between a minimum clearance and a maximum clearance,
wherein the side surfaces (23, 31) touch each other at least partially or are spaced apart from each other by the gap (37) having a clearance B (38)
and
the centring ring (5) has at least one movement limiter (24, 48) which has at least one contact surface (32, 33, 41, 49, 50) and/or at least one end face (40) and by means of which a drifting apart of the side surfaces (23, 31) under the application of force is merely possible until the maximum clearance is reached and/or by means of which a drifting of the side surfaces (23, 31) towards each other under the application of force is merely possible until the minimum clearance is reached.

2. The centring ring (5) as claimed in claim 1,
characterised in that
the side surface (23) is arranged on the end face of the first thick-walled segment (15) and/or the side surface (31) is arranged on the end face of the second thick-walled segment (16).

3. The centring ring (5) as claimed in claim 1,
characterised in that
at least one movement limiter (24) is arranged on the side surface (23) of the first thick-walled segment (15) and/or at least one movement limiter (24) is arranged on the side surface (31) of the second thick-walled segment (16) and/or at least one movement limiter (48) constitutes a separate component.

4. The centring ring (5) as claimed in claim 1,
characterised in that
at least one thick-walled segment has at least one contact surface (39) for at least one movement limiter (24, 48).

5. The centring ring (5) as claimed in claim 4,
characterised in that
at least one contact surface (39) is arranged in a cavity (25) formed within a thick-walled segment.

6. The centring ring (5) as claimed in claim 1,
characterised in that
a tongue-and-groove connection is formed between a movement limiter (24, 48) and a thick-walled segment by the movement limiter (24, 48) having at least one groove arranged thereon and the thick-walled segment having at least one corresponding tongue arranged thereon, and/or by the movement limiter (24, 48) having at least one tongue arranged thereon and the thick-walled segment having at least one corresponding groove arranged thereon.

7. The centring ring (5) as claimed in claim 1
characterised in that
a tongue-and-groove connection is formed between one movement limiter (24, 48) and another movement limiter (24, 48) by the one movement limiter (24, 48) having at least one groove arranged thereon and the other movement limiter (24, 48) having at least one corresponding tongue arranged thereon, and/or by the one movement limiter (24, 48) having at least one tongue arranged thereon and the other movement limiter (24, 48) having at least one corresponding groove arranged thereon.

8. The centring ring (5) as claimed in claim 1
characterised in that
the centring ring (5) has a first thin-walled segment (18) and a second thin-walled segment (19), said first thin-walled segment (18) being arranged adjacent to the first thick-walled segment (15) and said second thin-walled segment (19) being arranged adjacent to the second thick-walled segment (16).

9. The centring ring (5) as claimed in claim 8,
characterised in that
a thick-walled segment, i.e. a third thick-walled segment (17) is arranged between the first thin-walled segment 18 and the second thin-walled segment 19.

10. The centring ring (5) as claimed in claim 1;
characterised in that
one of the thick-walled segments has a connection bore (36).

11. The centring ring (5) as claimed in claim 1,
characterised in that
at least one thin-walled segment is in the form of a cable feed-through (20).

12. A method for reducing the risk of breakage of at least one thin-walled segment of a centring ring (5) for two-wheeled and three-wheeled vehicles, said centring ring (5) having at least two thick-walled segments, i.e. at least one first thick-walled segment (15) and one second thick-walled segment (16), said first thick-walled segment (15) having a side surface (23) which faces a side surface (31) of the second thick-walled segment (16),
characterised in that
said side surfaces (23, 31) have a gap (37) arranged therebetween which has a given clearance B (38), wherein said clearance B (38) is variable between a minimum clearance and a maximum clearance,
wherein the side surfaces (23, 31) touch each other at least partially or are spaced apart from each other by the gap (30) having a clearance B (38)
and
the centring ring (5) has at least one movement limiter (24, 48) which has at least one contact surface (32, 33, 41, 49, 50) and/or at least one end face (40) and by means of which a drifting apart of the side surfaces (23, 31) under the application of force is merely enabled until the maximum clearance is reached and/or by means of which a drifting of the side surfaces (23, 31) towards each other under the application of force is merely enabled until the minimum clearance is reached.

13. The method as claimed in claim 12,
characterised in that
a drifting apart of the side surfaces (23, 31) under the application of force and/or their drifting towards each other under the application of force is decelerated or stopped as soon as at least one contact surface (32, 33, 41, 49, 50) of the movement limiter (24, 48) comes into contact with at least one contact surface (34, 35, 42) arranged on a thick-walled segment or as soon as the end face (40) of the movement limiter (24, 48) comes into contact with at least one contact surface (39) arranged within a cavity (25) formed in a thick-walled segment.

14. The method as claimed in claim 12,
characterised in that
at least one of the movement limiters (48) has at least two contact surfaces (41), i.e. a first contact surface (49) and a second contact surface (50), so that a drifting apart of the side surfaces (23, 31) under the application of force and/or their drifting towards each other under the application of force is decelerated or stopped as soon as the first contact surface (49) of the movement limiter (48) comes into contact with at least one contact surface (42) arranged on a first thick-walled segment (15) and the second contact surface (50) of the movement limiter (48) comes into contact with at least one contact surface (42) arranged on a second thick-walled segment (16).

15. The method as claimed in claim 12,
characterised in that
at least one of the movement limiters (48) has at least two contact surfaces (41), i.e. a first contact surface (48) and a second contact surface (49), so that a drifting apart of the side surfaces (23, 31) under the application of force and/or their drifting towards each other under the application of force is decelerated or stopped as soon as the first contact surface (48) of the movement limiter (48) comes into contact with at least one contact surface (42) arranged on a first thick-walled segment and the second contact surface (50) of the movement limiter (48) comes into contact with a contact surface (41) arranged on a second movement limiter (24, 48).

16. The method as claimed in claim 12,
characterised in that
at least one of the movement limiters (24, 48) has at least two contact surfaces (41, 49, 50), so that a drifting apart of the side surfaces (23, 31) under the application of force and/or their drifting towards each other under the application of force is decelerated or stopped as soon as at least one of the contact surfaces (41, 49, 50) of the movement limiter (24) comes into contact with at least one contact surface (41, 49, 50) arranged on a second movement limiter (24, 48).

17. The method as claimed in claim 12,
characterised in that
a transmission of forces between two thick-walled segments of the centring ring (5) is established at the latest when the given clearance B (38) as specified by the movement limiter(s) (24, 48) is reached.

18. The method as claimed in claim 12,
characterised in that
the centring ring (5) is used in a steering head bearing of a vehicle.

19. The method as claimed in claim 12,
characterised in that
the centring ring (5) employed is a centring ring (5) as claimed in claim 1.
